(19) United States
(12) Patent Application Publication
(10) Pub. No.: US 2008/0144901 A1
(43) Pub. Date: Jun. 19, 2008

(54) Cartoon-like exaggeration of medical images to emphasize abnormalities

(75) Inventor: David Thomas Gering, Waukesha, WI (US)

Correspondence Address: DEAN D. SMALL;THE SMALL PATENT LAW GROUP LLP, 611 OLIVE STREET, SUITE 1611, ST. LOUIS, MO, 63101, US

(73) Assignee: GENERAL ELECTRIC COMPANY

(21) Appl. No.: 11/586,077

(22) Filed: Oct. 25, 2006

(51) Int. Cl. G06K 9/00

(52) U.S. Cl. 382/130

(57) ABSTRACT

A method for displaying a medical image using a computer controlling a display includes animating a stored medical image by smoothly altering properties of the stored medical image between at least a first image and a second image, not necessarily in that order, wherein the second image exaggerates an abnormal physiological characteristic represented in the stored medical image, and displaying the animated image.

### BACKGROUND OF THE INVENTION

This invention relates generally to computer-aided detection systems for analyzing medical images, and more particularly to methods and apparatus for emphasizing abnormalities in such systems.

At least one known computer-aided detection (CAD) system can analyze medical images to find abnormalities and report these findings to an attending radiologist. This report sometimes includes highlighting of images to draw the attention of the radiologist to areas that CAD software analysis indicated may be interesting. One example of such a system is found in U.S. Pat. Pub. No. 20020097902A1, Ser. No. 990,508, filed Nov. 21, 2001 by Roehrig, et al., and published Jul. 25, 2002, entitled “Method and system for the display of regions of interest in medical images.”

In virtual colonoscopy, reports can include coloring not only the image data itself, but also generating a 3-D surface from the image data. Three dimensional surface rendering is well-suited for applications such as magnetic resonance imaging (MRI), where segmentation of key structures is a necessary or desirable step for good visualization. A polygonal mesh can be wrapped around segmented structures to form a surface model. Surfaces can also be viewed using volume rendering, but volume rendering is only practicable for applications (e.g., computed tomographic [CT] data), for which assignment of color and opacity values is straightforward given the image voxel intensities. The assignment of color and opacity values is straightforward for CT data because there is a strong correlation between CT Hounsfield units and tissue types.

In shape analysis, surfaces of segmented anatomical structures can be colored in accordance with a deviation from a normal population.

There are many patents in the field of virtual endoscopy (U.S. Pat. No. 5,611,025, U.S. Pat. No. 5,782,762, U.S. Pat. No. 6,343,936), especially for generating dynamic views of static data. However, none of these references teach or suggest virtual endoscopy with dynamic data. Although U.S. Pat. No. 6,892,090 describes dynamic data coming from a tracking system, there is no teaching or suggestion of dynamic data coming from a surface of an organ.

### BRIEF DESCRIPTION OF THE INVENTION

In one aspect, some configurations of the present invention provide a method for displaying a medical image using a computer controlling a display. The method includes animating a stored medical image by smoothly altering properties of the stored medical image between at least a first image and a second image, not necessarily in that order, wherein the second image exaggerates an abnormal physiological characteristic represented in the stored medical image, and displaying the animated image.

In another aspect, some configurations of the present invention provide an apparatus for displaying medical images. The apparatus includes a computer and a controlled display. The computer is configured to animate a stored medical image by smoothly altering properties of the stored medical image between at least a first image and a second image, not necessarily in that order, wherein the second image exaggerates an abnormal physiological characteristic represented in the stored medical image, and to display the animated image on the controlled display.

It will be appreciated that some configurations of the present invention provides animated images in which subtle features become more apparent, in at least two ways. First, exaggeration makes features more pronounced. Misdiagnosis from simple exaggeration is prevented in various configurations of the present invention by using dynamic “cine” between realistic and exaggerated images. Second, morphing back and forth between realistic and exaggerated images exploits the strength of the human visual system for noticing changes. The viewer's attention is thereby drawn to important areas.

### BRIEF DESCRIPTION OF THE DRAWINGS

FIG. 1 is a representation of an animation of an image of a right hippocampus of a schizophrenic patient in which colors representing deformation range from normal colors to exaggerated colors.

FIG. 2 is a representation of an animation of an image of a right hippocampus of a schizophrenic patient in which the animation ranges from an image of a normal hippocampus to an image of the hippocampus of the schizophrenic patient (with the same normal deformational coloring as in FIG. 1) to an image in which both the colors and shapes of abnormalities are exaggerated.

FIG. 3 is a represent of a 3-D animation of the surface of a colon for virtual endoscopy in which the geometry of an abnormality ranges from normal to greatly exaggerated.

FIG. 4 is a pictorial representation of an apparatus configuration of the present invention.

FIG. 5 is a flow chart representation of a method configuration of the present invention.

FIG. 6 is a drawing of an example of a time-varying mapping function displayed in a window/level interface that is configured to allow a user to alter the time-varying transfer function, such as by using a mouse.

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

### DETAILED DESCRIPTION OF THE INVENTION

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Instead of rendering scenes of medical imagery with a static realism, some configurations of the present invention render the scenes dynamically such that the view oscillates between a realistic view and an exaggerated view. The effect is similar to that of cartoon animation in which objects are routinely stretched into unrealistic deformations, but only momentarily before reverting back to their original form. In some configurations, images are viewed using a 2-D display, and in another exemplary configuration described herein, image surfaces are viewed as 3-D renderings. In either case, the exaggerated view can include false or exaggerated colors and/or geometric deformations. In addition, the medical images can be either static images or cine images. Thus, distortions to aid recognition of abnormalities, such as color changes and/or geometric deformations, can be applied in some configurations even as the medical image changes for some other reason, such as the movement of a catheter through a lumen or the colon, or 3-D navigation through a set of images, such as live or stored computed tomographic (CT) images.

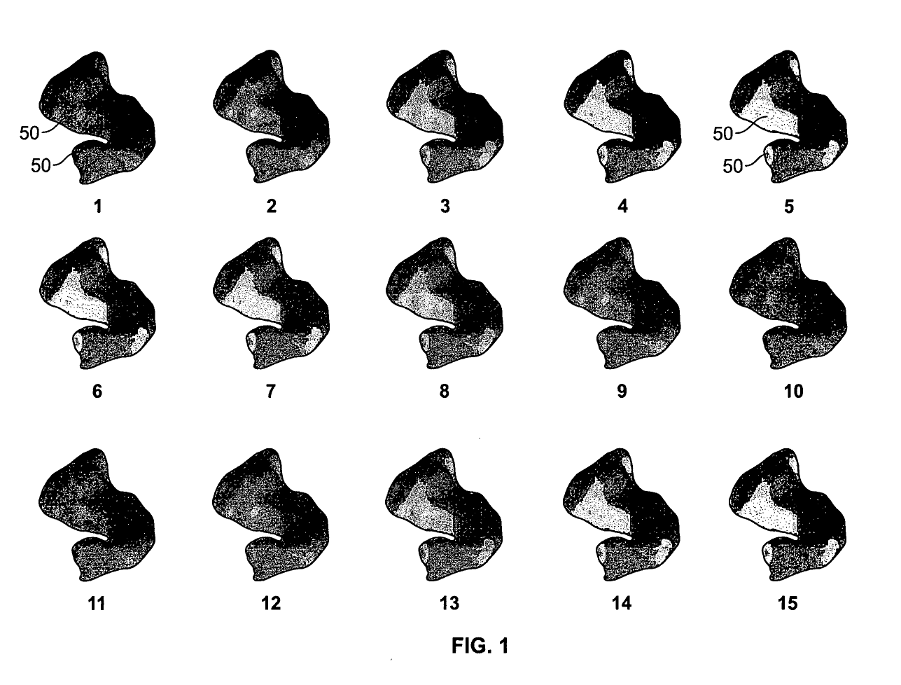

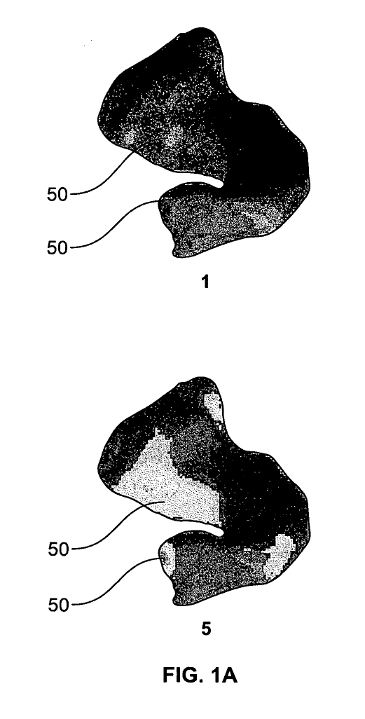

At least one known 2-D viewing system for medical images provides a window/level interface that allows a user to alter a transfer function that relates image pixel values with colors from a palette. However, many configurations of the present invention animate an image to be rendered with a transfer function that varies over time, alternating between, for example, a linear and an exponentially non-linear form. The effect produced by such embodiments exploits the skill of the human visual system for distinguishing change. Miniscule bright spots, such as small masses on mammography radiographs, are momentarily accentuated and de-accentuated by a dynamic display, resulting in a pulsating action that can lead to better lesion detection. See, for example, FIG. 1, where the sequence of images 1-15 represents an animation sequence between a stored medical image of a right hippocampus of a schizophrenia patient. (Of course, the animation sequence can continue indefinitely beyond image 15.) The stored medical image is represented by images 1, 10, and 11. A color mapping in images 1, 10, and 11 ranges from blue (inward deformation) through the spectrum to red (outward deformation) indicates abnormalities in the hippocampus. The animation sequence varies from the stored image at 1 to an exaggerated image 5, where the abnormal areas 50 are exaggerated in color to draw attention to them. The animation then proceeds from 6 (which is the same image as 5 in this configuration) to 10 and 11 (which are the same image as 1 in this configuration), and then to 15 (which is the same as 5 and 6 in this configuration). If this sequence were continued, images identical to those of 6 through 10 would follow image 15.

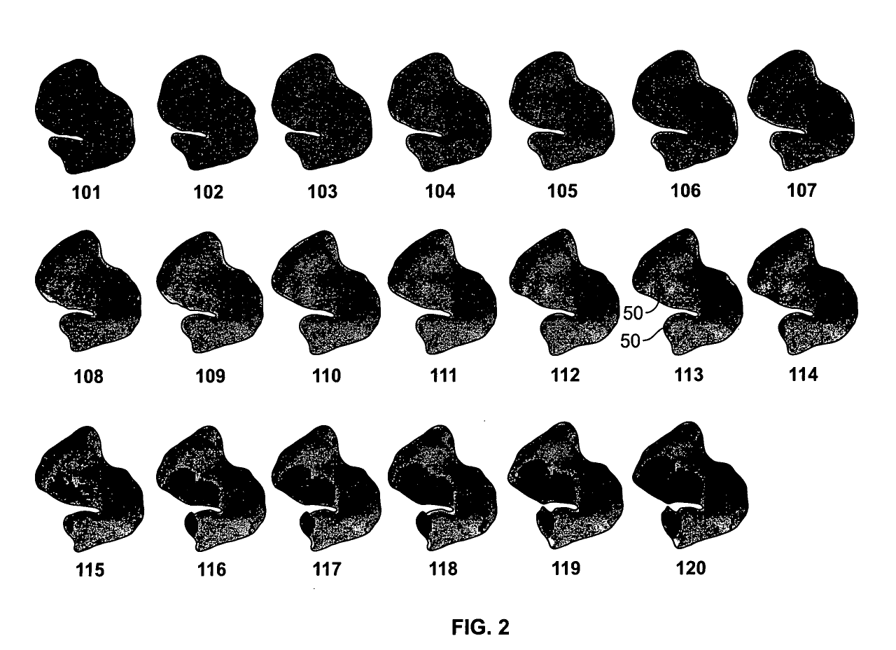

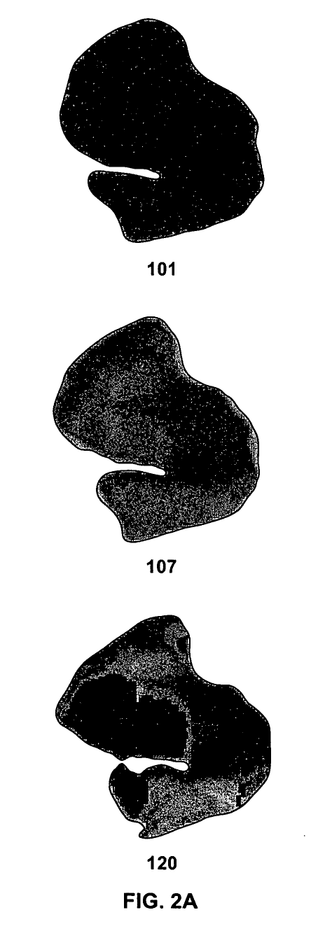

For example, cartoon-like dynamics are applied to a coloring process, as described above, or to surface geometry, or both. For example, and referring to FIG. 2, a time-varying transfer function in some configurations is applied to both show curvature-based coloring and to exaggerate portions of an image to emphasize abnormalities in a medical image. In FIG. 2, images 101 to 120 represent an alternate animation of the same stored medical image of the right hippocampus of the schizophrenia patient as in FIG. 1. Image 101 is, however, an image of a normal hippocampus, whereas image 113 is the stored patient image with abnormalities 50 (with colors showing inward deformations in blue and outward deformations in red), and image 120 is an image with geometric and color distortions to emphasize the abnormalities.

In some further configurations, the coloring scheme dynamically alternates between a realistic coloring and a curvature-based coloring. Like a cartoon, the full cycle of blending from real to augmented, and back to real, can be made in one or two seconds. A similar pulsation could be used with deviation-based coloring, as in FIGS. 1 and 2.

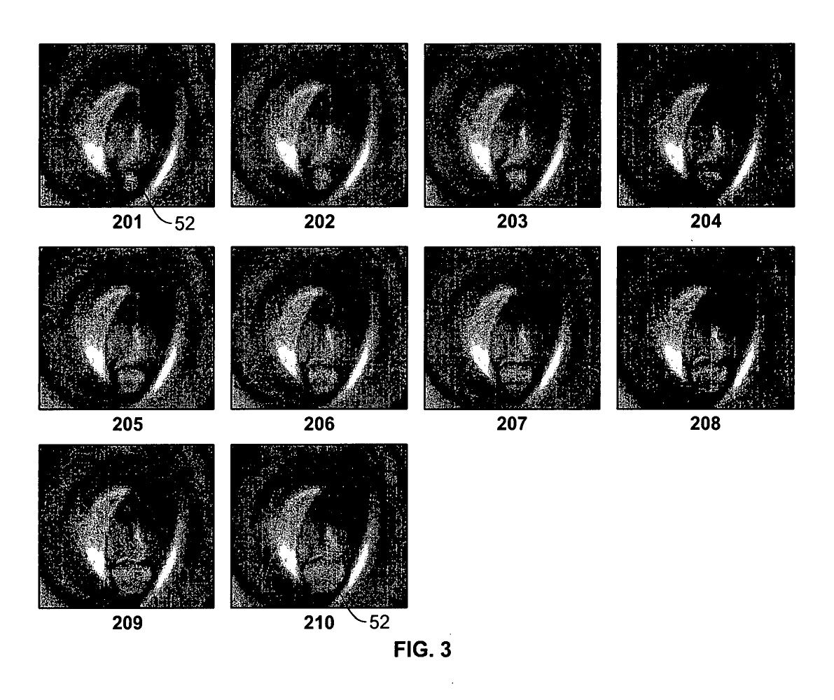

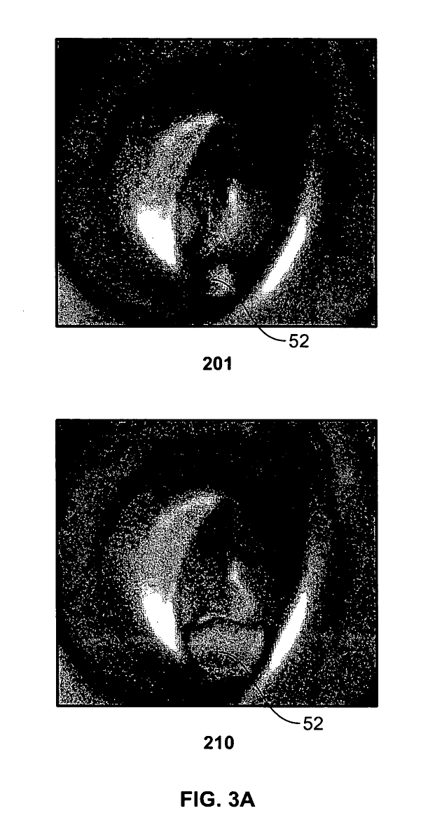

In some configurations of the present invention and referring to FIG. 3, cartoon-like dynamics are applied to warp the geometric shape of surfaces. For example, a normal surface of a colon in virtual endoscopy 201 having an abnormality 52 is animated by warping abnormality 52 in the sequence of images 201 to 210. For example, such a warping can be achieved by applying a filter to a triangle mesh that represents the surface of the colon. This filter warps the mesh by moving the position of each mesh vertex in proportion to the local curvature. A time-varying transfer function is applied to modulate the degree of warping. The result is that images of abnormal structures, such as polyps, would momentarily grow to appear even more abnormal, then shrink back to a realistic image, then grow more pronounced again, etc. Abnormal structures would become quite apparent when this surface morphing effect is applied to deviations from a known population. Inward bends would bend even further inward, and outward protrusions would extend even further outward, so that the differences from the norm would appear very obvious from the dynamic display.

Morphing need not be limited to oscillating between realistic and exaggerated in configurations of the present invention. For example, morphing could vary from normal (as measured from a control population), to patient-specific, and then to exaggerated. Some configurations of the present invention avoid exaggeration altogether by varying between patient-specific and a control group. Configurations that vary between patient-specific and a control group can be used for comparing surface data for a specific patient with a healthy surface, or for comparing the patient's surface with one of various surfaces that are characteristic of various diseases. Although warping one anatomical surface into another is known, the use of a “cine” display as described here between a patient and a population is believed to be novel, as is the technique of highlighting deviations with coloring.

Computing a morphing that exaggerates deviations from a population is a bit more complicated than the case described earlier of morphing to exaggerate local curvature. However, there are several known algorithms for morphing between two different surfaces. By applying one of the known algorithms to move from one surface to the next, exaggeration can be achieved by extrapolating the final motions further along their trends. This technique can be applied to any two surfaces without having an understanding of the relationships between them. However, when some analysis has been performed, a more plausible morphing can be computed. Techniques for shape analysis sometimes involve performing principle component analysis (PCA) to find a population's modes of variation. In some configurations of the present invention, PCA is used to express a given surface as a linear combination of principle component surfaces, or “eigensurfaces”. In this representation, the deviation of a surface from a mean surface can be understood from the strength (weighing coefficient) assigned along each mode of variation. Then, an exaggerated surface can be computed by scaling these coefficients further.

The cartoon-like display renders views that dynamically flow, or morph, between two alternatives, such as, for example, the following pairs: (1) a 2-D image colored using linear transfer function to a 2-image colored using a non-linear transfer function; (2) a 3-D surface colored using a linear transfer function into a 3-D surface using a non-linear transfer function; (3) a 3-D surface with realistic geometry into a 3-D surface with exaggerated geometry; or (4) a 3-D surface from a specific patient to a 3-D surface of a population (normal or pathology).

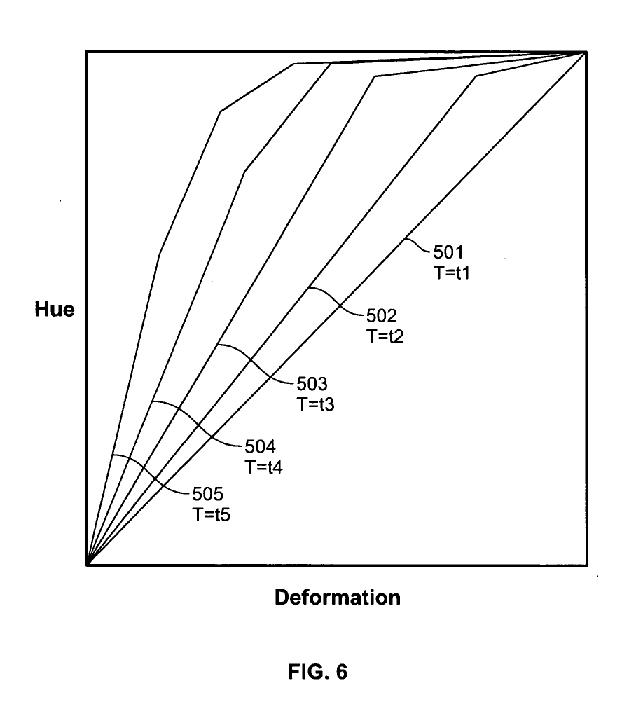

Thus, and referring to FIGS. 1, 4, and 5, some configurations of the present invention provide a method for displaying a medical image using a computer 302 controlling a display 304. The method includes, at block 402, animating a stored medical image 1 by smoothly altering properties of the stored medical image 1 between at least a first image 1 and a second image 5, not necessarily in that order, wherein second image 5 exaggerates an abnormal physiological characteristic 50 represented in stored medical image 1, and, at block 404, displaying the animated image 1 through 15. In some of these configurations and now also referring to FIG. 6, the method is applied to a 2-D stored medical image 1 and the method further comprises, at block 406, using a transfer function 501, 502, 503, 504, 505 that varies over time T to assign function values to pixel values of the stored medical image to animate stored medical image 1. These configurations can further include varying the transfer function between a linear function and a non-linear function in the displayed images 1-15 to momentarily accentuate and de-accentuate the abnormal physiological characteristic 50 represented in stored medical image 1. The time-varying, non-linear transfer function maps colors to pixel values, and now referring also to FIG. 6, the method may further include, at block 410, displaying a window/level interface configured to allow a user to alter the time-varying, non-linear transfer function, such as by using a mouse, allowing the user to alter the time-varying, non-linear transfer function at block 412, and using the altered time-varying, non-linear transfer function to assign colors to the pixel values of the stored medical image at block 406.

In some configurations of the present invention, the stored medical image is a 3-D medical image. In some configurations of the methods applied to 3-D images, the method may include using a transfer function 501 to 505 that varies over time to assign function values to pixel values of the stored medical image to animate the stored medical image. The method may also include using the time-varying transfer function to map colors to pixel values, and also displaying a window/level interface that allows a user to alter the time-varying transfer function, allowing the user to alter the time-varying transfer function, and using the altered time-varying transfer function to assign colors to the pixel values of the animated medical image.

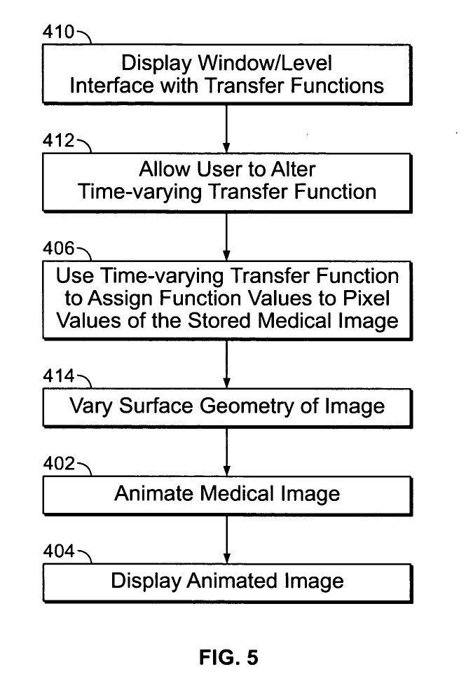

In some configurations of methods applied to 3-D images and referring to FIGS. 3 and 5, the method includes, at block 414, varying a surface geometry 52 of the displayed image. Varying the surface geometry of the displayed image can comprise, in some configurations, displaying a mesh representing surfaces of the displayed image, and animating the displayed image can comprise warping the mesh.

In some configurations of the present invention, the method is applied to deviations from a known population.

In various configurations of the present invention and referring to FIG. 2, the method includes smoothly altering properties of stored medical image 113 back and forth to include a normal image 101, a patient-specific image 113, and an exaggerated image 120.

In some configurations of the present invention, the stored medical image is a cine image, and the animation comprises smoothly altering properties of the stored cine medical image between at least a first cine image and a second cine image, not necessarily in that order, wherein the second cine image exaggerates an abnormal physiological characteristic represented in the stored cine medical image, and displaying the animated cine image.

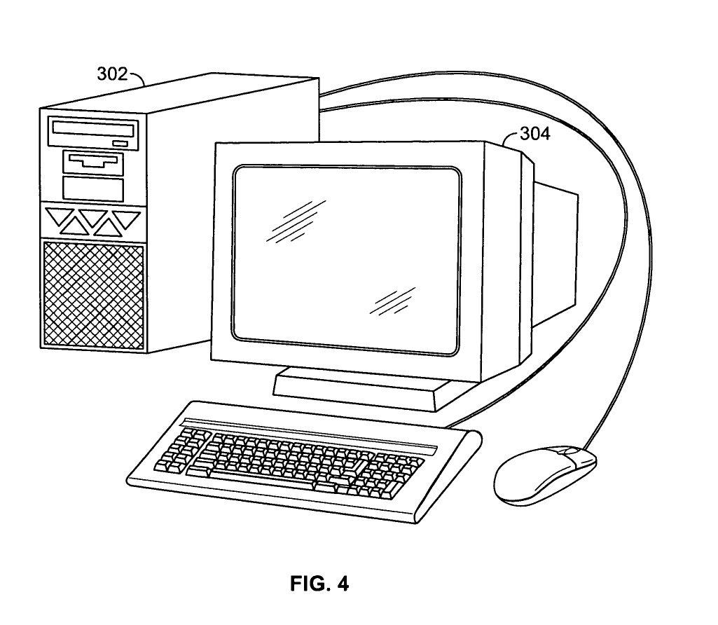

Again referring to FIGS. 1 and 4, some configurations of the present invention provide an apparatus for displaying medical images. The apparatus includes a computer 302 and a controlled display 304. Computer 302 is configured to animate a stored medical image 1 by smoothly altering properties of the stored medical image between at least a first image 1 and a second image 5, not necessarily in that order, wherein second image 5 exaggerates an abnormal physiological characteristic 50 represented in stored medical image 1, and to display animated image 1 through 15 on controlled display 304. In some configurations, and now also referring to FIG. 6, the apparatus is further configured to use a transfer function 501, 502, 503, 504, 505 that varies over time to assign function values to pixel values of a stored 2-D medical image 1 in order to animate stored 2-D medical image 1. The apparatus may also be configured to vary transfer function 501 through 505 between a linear function 501 and a non-linear function 505 in the displayed image to momentarily accentuate and de-accentuate abnormal physiological characteristic 50 represented in stored medical image 1. The time-varying, non-linear transfer function can map colors to pixel values. The apparatus may further be configured to display a window/level interface (see FIG. 6) that is configured to allow a user to alter the time-varying, non-linear transfer function, such as by using a mouse, to accept an altered the time-varying, non-linear transfer function, and to use the altered time-varying, non-linear transfer function to assign colors to the pixel values of stored medical image 1.

In some configurations of the apparatus and referring to FIG. 3, the apparatus is configured to use a transfer function that varies over time to assign function values to pixel values of a stored 3-D medical image 201 in order to animate stored 3-D medical image 201. The apparatus may also be configured to animate the stored 3-D medical image by varying a surface geometry 52 of the displayed image 201 to 210. In some configurations, to vary surface geometry 52, the apparatus is configured to display a mesh representing surfaces of the displayed image, and to animate the displayed image, said apparatus further configured to warp the mesh.

In some configurations of the present invention, the apparatus is configured to smoothly alter properties of stored medical image 1 back and forth to include a normal image 101, a patient-specific image 113, and an exaggerated image 120.

The diagnostic advantage of configurations of the present invention is that subtle features become more apparent, in at least two ways. First, the exaggeration makes features more pronounced. Misdiagnosis from simple exaggeration is prevented in various configurations of the present invention by using dynamic “cine” between realistic and exaggerated images. Second, morphing back and forth between realistic and exaggerated images exploits the strength of the human visual system for noticing changes. The viewer's attention is thereby drawn to important areas.

While the invention has been described in terms of various specific embodiments, those skilled in the art will recognize that the invention can be practiced with modification within the spirit and scope of the claims.

What is claimed is:

1. A method for displaying a medical image using a computer controlling a display, said method comprising animating a stored medical image by smoothly altering properties of the stored medical image between at least a first image and a second image, not necessarily in that order, wherein the second image exaggerates an abnormal physiological characteristic represented in the stored medical image, and displaying the animated image.

2. The method of claim 1 applied to a 2-D stored medical image and the method further comprises using a transfer function that varies over time to assign function values to pixel values of the stored medical image to animate the stored medical image.

3. The method of claim 2 further comprising varying the transfer function between a linear function and a non-linear function in the displayed image to momentarily accentuate and de-accentuate the abnormal physiological characteristic represented in the stored medical image.

4. The method of claim 3 wherein the time-varying, non-linear transfer function maps colors to pixel values, and said method further comprising displaying a window/level interface configured to allow a user to alter the time-varying, non-linear transfer function, allowing the user to alter the time-varying, non-linear transfer function, and using the altered time-varying, non-linear transfer function to assign colors to the pixel values of the stored medical image.

5. The method of claim 1 wherein said displaying the stored medical image further comprises displaying a stored 3-D medical image.

6. The method of claim 5 further comprising using a transfer function that varies over time to assign function values to pixel values of the stored medical image to animate the stored medical image.

7. The method of claim 6 wherein the time-varying transfer function maps colors to pixel values, and further comprising displaying a window/level interface that allows a user to alter the time-varying transfer function, allowing the user to alter the time-varying transfer function, and using the altered time-varying transfer function to assign colors to the pixel values of the animated medical image.

8. The method of claim 5 wherein said animating the stored medical image comprises varying a surface geometry of the displayed image.

9. The method of claim 8 wherein said varying a surface geometry of the displayed image comprises displaying a mesh representing surfaces of the displayed image, and said animating the displayed image further comprises warping the mesh.

10. The method of claim 1 applied to deviations from a known population.

11. The method of claim 1 wherein said smoothly altering properties of the stored medical image between at least a first image and a second image further comprises smoothly altering properties of the stored medical image back and forth to include a normal image, a patient-specific image, and an exaggerated image.

12. The method of claim 1 wherein the stored medical image is a cine image, and wherein said animating a stored medical image comprises smoothly altering properties of the stored cine medical image between at least a first cine image and a second cine image, not necessarily in that order, wherein the second cine image exaggerates an abnormal physiological characteristic represented in the stored cine medical image, and displaying the animated cine image.

13. An apparatus for displaying medical images, said apparatus comprising a computer and a controlled display, said computer configured to animate a stored medical image by smoothly altering properties of the stored medical image between at least a first image and a second image, not necessarily in that order, wherein the second image exaggerates an abnormal physiological characteristic represented in the stored medical image, and to display the animated image on the controlled display.

14. The apparatus of claim 13 further configured to use a transfer function that varies over time to assign function values to pixel values of a stored 2-D medical image in order to animate the stored 2-D medical image.

15. The apparatus of claim 14 further configured to vary the transfer function between a linear function and a non-linear function in the displayed image to momentarily accentuate and de-accentuate the abnormal physiological characteristic represented in the stored medical image.

16. The apparatus of claim 15 wherein the time-varying, non-linear transfer function maps colors to pixel values, and said apparatus further configured to display a window/level interface that is configured to allow a user to alter the time-varying, non-linear transfer function, accept an altered the time-varying, non-linear transfer function, and use the altered time-varying, non-linear transfer function to assign colors to the pixel values of the stored medical image.

17. The apparatus of claim 13 further configured to use a transfer function that varies over time to assign function values to pixel values of a stored 3-D medical image in order to animate the stored 3-D medical image.

18. The apparatus of claim 17 configured to animate the stored 3-D medical image by varying a surface geometry of the displayed image.

19. The apparatus of claim 18 wherein to vary a surface geometry of the displayed image, said apparatus configured to display a mesh representing surfaces of the displayed image, and to animate the displayed image, said apparatus further configured to warp the mesh.

20. The apparatus of claim 13 wherein to smoothly alter properties of the stored medical image between at least a first image and a second image, said apparatus further configured to smoothly alter properties of the stored medical image back and forth to include a normal image, a patient-specific image, and an exaggerated image.
